(19) United States
(12) Patent Application Publication
(10) Pub. No.: US 2026/0227547 A1
(43) Pub. Date: Aug. 6, 2026

(54) WEATHER FORECASTING WITH GRAPH NEURAL NETWORKS USING MULTI-MESH REPRESENTATIONS

(71) Applicant: DeepMind Technologies Limited, London (GB)

(72) Inventors: Peter Wirnsberger, London (GB); Remi Roger Alain Paul Lam, London (GB); Matthew James Willson, London (GB); Alexander Pritzel, London (GB); Alvaro Sanchez, London (GB); Meire Fortunato, London (GB); Peter William Battaglia, London (GB)

(21) Appl. No.: 19/142,526

(22) PCT Filed: Dec. 22, 2023
(86) PCT No.: PCT/EP2023/087641

§ 371 Date: Jun. 23, 2025

Related U.S. Application Data
(60) Provisional application No. 63/435,163, filed on Dec. 23, 2022.

(51) Int. Cl. G01W 1/10; G06N 3/0455

(52) U.S. Cl. CPC G01W 1/10; G06N 3/0455

(57) ABSTRACT

Methods, systems, and apparatus, including computer programs encoded on computer storage media, for predicting weather using graph neural networks. One of the methods includes obtaining current weather data for a current time step; generating, using the current weather data, current graph data representing a current state of a graph of the surface; and processing the current graph data using a graph neural network to generate a first prediction output that defines first future weather data.

### BACKGROUND

This specification relates to using neural networks to perform weather forecasting. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates predicted weather forecasts. In particular, the system generates a predicted weather forecast by processing a multi-mesh representation of a graph of a surface using a graph neural network.

A weather forecast, as used in this specification, is a prediction of the values of one or more weather properties, e.g., atmospheric properties, surface properties, or both, at one or more locations at a future time.

Particular embodiments of the subject matter described in this specification can be implemented so as to realize one or more of the following advantages.

Conventional weather forecasts, e.g., medium-range weather forecasts, are generally generated using numerical weather prediction (NWP), which attempts to approximate the governing equations of weather numerically. The most accurate conventional approaches perform NWP using an enormous amount of compute, e.g., using some of the largest supercomputers in the world.

However, these NWP systems do not scale well with increasing amounts of available data. Instead, the primary way that NWP methods are improved is through highly trained experts manually innovating better models, algorithms, and approximations, which is a time-consuming and costly process.

While machine learning systems do scale well with additional data, existing machine learning approaches have not shown to perform as well as the best NWP methods, e.g., on medium-range weather forecasting tasks.

This specification describes a system that uses a graph neural network to generate weather forecasts that are as accurate as and, in many cases, superior to the highest-performing NWP methods. By making use of the graph neural network as described in this specification, at prediction time, the described system uses significantly less computational resources than the highest-performing NWP systems and generates predicted forecasts with significantly reduced latency. As a particular example, on a single hardware accelerator device, e.g., a Cloud TPU v4 device, the described system can generate a 0.25° resolution, 10-day forecast (that includes respective predictions at each 6-hour step during the 10 days) in under 60 seconds. For comparison, a high performing NWP system, ECMWF's IFS system, runs on a 11,664-core cluster, and generates a 0.1° resolution, 10-day forecast (released at 1-hour steps for the first 90 hours, 3-hour steps for hours 93-144, and 6-hour steps from 150-240 hours) in about an hour. Despite being significantly more computationally efficient, the described system nonetheless generates predictions that are at least comparable to and in many cases more accurate than the IFS system.

In particular, the described system uses a “multi-mesh” representation that leverages meshes at multiple different coarseness scales. By making use of the multi-mesh representation, the system can use the graph neural network to effectively (and in a computationally efficient manner) propagate information across space, i.e., to model both short-range and long-range interactions, in order to improve the quality of the predicted weather forecasts.

Moreover, the system can auto-regressively generate multi-step forecasts (“forecast trajectories”) conditioned on previous model predictions, allowing the system to effectively model the evolution of weather across time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example forecasting system.

FIG. 2 is a flow diagram of an example process for performing forecasting for a given real-world location.

FIG. 3 is a flow diagram of an example process for processing the graph data using the graph neural network.

FIG. 4 shows the encode-process-decode configuration.

FIG. 5 shows an example of auto-regressively rolling out a weather forecast.

Like reference numbers and designations in the various drawings indicate like elements.

### DETAILED DESCRIPTION

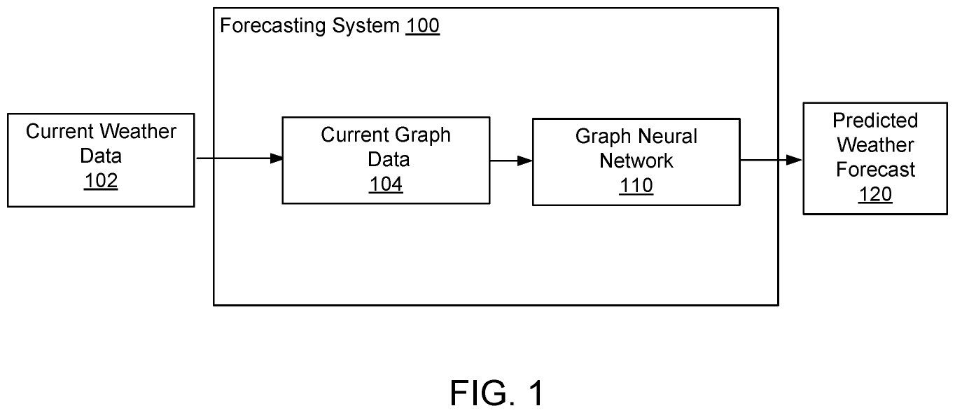

FIG. 1 shows an example forecasting system 100. The forecasting system 100 is an example of a system implemented as computer programs on one or more computers in one or more locations, in which the systems, components, and techniques described below can be implemented.

The system 100 generates predicted weather forecasts using a graph neural network 110.

To generate a predicted weather forecast 120, the system 100 obtains current weather data 102 for a current time step, e.g., the mostly-recently measured or observed weather data as of the time point (time step) at which the prediction is being made.

The current weather data 102 is defined on a latitude-longitude grid over a surface of a body, e.g., over some or all of the surface of a celestial object, e.g., over the Earth or a different planet.

A “latitude-longitude” grid is a grid that has one axis that corresponds to latitude and another axis that corresponds to longitude, so that each point on the grid has a corresponding latitude value and a corresponding longitude value. For example, the grid can be placed on the surface of the body at a specified resolution, e.g., 0.1 degrees, 0.25 degrees, 0.5 degrees, or 0.75 degrees. For example, when the grid is placed over the surface of the Earth at a 0.25 degree resolution, each grid cell is 721×1440, which corresponds to roughly 28×28 kilometer resolution at the equator of the Earth.

Generally, the current weather data 102 includes, for each of a plurality of points on the latitude-longitude grid, current weather properties at the point as of the current time step.

The current weather properties can include properties of the surface at the point, properties of the atmosphere above the surface at the point, or both.

For example, surface properties can include any of temperature, wind speed, wind direction, air pressure, precipitation levels, and so on.

Atmospheric properties can include, for each of multiple vertical (pressure) levels, where each level is a different pressure level above the point, any one of humidity, temperature wind speed, wind direction, geopotential, vertical wind velocity, and so on. For example, the atmospheric properties may comprise, “geopotential” at a pressure level of 500 hPa.

Table 1 shows one example of the set of surface and atmospheric properties that can be included in the current weather data 120 and one example of the set of pressure levels at which each atmospheric property can be measured.

TABLE 1

| Surface | Atmospheric | |
|---|---|---|
| variables (5) | variables (6) | Pressure levels (37) |
| 2-meter temperature | Temperature (T) | 1, 2, 3, 5, 7, 10, 20, 30, |
| (2T) | U component of | 50, 70, 100, 125, 150, |
| 10 metre u wind | wind (U) | 175, 200, 225, 250, 300, |
| component (10U) | V component of | 350, 400, 450, 500, 550, |
| 10 metre v wind | wind (V) | 600, 650, 700, 750, 775, |
| component (10V) | Geopotential (Z) | 800, 825, 850, 875, 900, |
| Mean sea-level | Specific humidity (Q) | 925, 950, 975, 1000 |
| pressure (MSL) | Vertical wind speed | |
| Total precipitation | (W) | |
| (TP) | | |

The current weather data 102 can also include one or more weather-independent properties for each point, e.g., latitude and longitude, time of day, time of year, and optionally other properties, e.g., solar radiation.

The system 100 generates, using the current weather data 102, current graph data 104 representing a current state of a graph of the surface.

The graph of the surface generally includes multiple nodes, which, in turn, include grid nodes and mesh nodes.

Each grid node corresponds to one of the points on the latitude-longitude grid while each mesh node corresponds to a node in a mesh that is placed around (on) the surface at a particular scale. For example, the mesh can be an icosahedral mesh over the surface.

The graph also includes edges, which in turn include a set of mesh edges.

The mesh edges include mesh edges corresponding to multiple meshes at different scales. In particular, the mesh edges include respective edges corresponding to the mesh at the particular scale and to one or more meshes at respective coarser scales than the particular scale. The particular scale will also be referred as a “first scale” and the one or more coarser scales will also be referred to as “second scales.”

More specifically, the mesh edges include (i) a respective first scale mesh edge connecting each pair of mesh nodes that are connected in the first mesh that is placed around the surface at the first scale and (ii) for each of one or more second scales that are coarser than the first scale, a respective second scale mesh edge connecting each pair of mesh nodes that would be connected in a corresponding second mesh that is placed around the surface at the second scale.

Thus, the graph is a “multi-mesh” representation, because it includes edges from meshes at multiple levels of a mesh hierarchy, i.e., a hierarchy that includes meshes at multiple different coarseness scales (i.e. spatial resolutions). In other words, the multiple edges define a mesh hierarchy of meshes at different scales. In some implementations, for each mesh other than the mesh of the finest scale, a respective different (proper) subset of the mesh nodes correspond to nodes from the mesh. That is, as a result of the hierarchy of coarseness scales, a different subset of the mesh nodes are included in each mesh other than the finest mesh (with all of the mesh nodes being included in the finest mesh).

As a result of the different meshes being at different coarseness scales, edges between mesh nodes that correspond to nodes from the one or more meshes that are coarser than the particular coarseness represent long distance dependencies and edges between mesh nodes that correspond to nodes from the first mesh represent local interactions.

The graph generally also includes one or more additional types of edge that allow information to propagate between mesh nodes and grid nodes during the operation of the graph neural network 110.

For example, the graph can include a set of grid-to-mesh edges. Each grid-to-mesh edge is a unidirectional edge from a respective grid node to a respective mesh node and a grid node is only connected to a mesh node by a grid-to-mesh edge if certain criteria are satisfied. For example, the criteria can specify that a given grid node is connected to a given mesh node by a grid-to-mesh edge only if a distance between the given mesh node and the given grid node is less than a threshold distance. As a particular example, the threshold distance can be based on lengths of the edges in the first mesh at the first scale.

Instead of or in addition to the grid-to-mesh edges, the graph can include a set of mesh-to-grid edges. Each mesh-to-grid edge is a unidirectional edge from a respective mesh node to a respective grid node and a mesh node is only connected to a grid node by a mesh-to-grid edge if certain criteria are satisfied. For example, the criteria can specify that a given mesh node is connected to a given grid node by a mesh-to-grid edge only if the given mesh node is adjacent to (e.g. a vertex of) a face of the first mesh at the first scale that contains the given grid node. For example, the first mesh may comprise triangular faces, each defined by the points of a respective three of the mesh nodes of the first mesh, and a given grid node may be connected to each of the three mesh nodes if the point of the grid code is within the area of the surface spanned by the corresponding triangular face.

The current graph data 104 that represents the current state of the graph includes respective embeddings for each of the nodes and edges in the graph, i.e., for each of the mesh nodes, grid nodes, and edges. An embedding is an ordered collection of numerical values, e.g., a vector of floating point or other numerical values having a specified dimensionality.

Generally, the system 100 generates the node and edge embeddings using the current weather data. Generating node and edge embeddings from current weather data will be described in more detail below.

In some cases, the current weather data includes, for each of the points on the latitude-longitude grid, weather properties at the point as of one or more preceding time steps that are each earlier than the current time step. That is, the current weather data includes preceding weather properties in addition to the current weather properties in order to provide additional context for the weather prediction. As one example, the current weather data can include weather properties at the current time step and the immediately preceding time step.

The system 100 processes the current graph data 104 using the graph neural network 110 to generate a prediction output that defines the predicted weather forecast 120.

In particular, the prediction output defines future weather data that includes, for each of the points on the latitude-longitude grid, predicted weather properties at the point as of a first future time step that is after the current time step.

Optionally, the system 100 can generate predictions for multiple future time points starting from the current time point by, for each future time point, “auto-regressively” using weather data generated using the graph neural network 110 for one or more preceding time points to generate the graph data that is provided as input to the graph neural network 110 for the future time point.

That is, the system can “roll-out” predictions generated using the graph neural network 110 to generate additional predictions using predicted weather data rather than actual, observed or measured weather data. In other words, when predicting weather data at a second future time point that is after the first future time point described above, the system 100 uses the predicted weather data generated using the graph neural network 110 for the first future time point to populate the graph data that is provided as input to the graph neural network 110 to generate the predicted weather data for the second future time point. When the weather data at a given time step includes properties for the given time point and one or more preceding time points, the system can use the predicted weather data for the given time point and the one or more preceding time points to generate predicted weather data for a future time point after the given time point. By repeating this process, the system 100 can generate a sequence of multiple weather predictions at multiple future time points starting from the current observed or measured weather data at the current time point (without obtaining any additional observed or measured weather data). In some examples, a combination of predicted weather data and actual, observed or measured weather data for time points equal to or preceding a given time point may be used to generate predicted weather data for a future time point after the given time point.

The weather forecasts generated by the system 100 can be referred to as “medium-range” forecasts, e.g., because the time interval between the current time point and the first future time point is between three and twelve hours, e.g., six hours.

For example, the system 100 can generate predictions at each of multiple six hour intervals into the future starting from the weather data for the current time point. Because of the way that the system 100 incorporates the graph neural network 110 and the multi-mesh representation, the forecasts can continue to be accurate (relative to other predictive approaches) even for time points far into the future relative to the current time points, e.g., time points that are five days or more after the current time point.

Once generated, the system 100 or another system can use the predicted weather data for any of a variety of purposes. Some examples now follow.

For example, the predictions can be used for “everyday” forecasting and the system can generate a user interface presentation that visually displays data characterizing the predicted values of one or more of the weather properties at each of one or more of the future time points. The system can provide the user interface presentation for viewing by users, e.g., in a user interface of a weather software application running on a user device, on a web page displayed in web browsers running on user devices, or by including the presentation as a “green screen” or other visualization in a streaming video or television broadcast.

As a particular example, a user can submit a query specifying a point on the grid, and the system can provide, in response, weather data characterizing predicted weather at the point at one or more of the future time points. Instead of or in addition to the user interface presentation, the system can generate speech describing the predicted value(s) and provide the speech for playback to users.

As another example, the predictions can be used for “extreme weather forecasting”, e.g., cyclone tracking, extreme heat, extreme cold, high and low rainfall, and so on. In these examples, the system can generate and provide an alert whenever the predicted value of a given property satisfies a specified threshold (that would indicate that an extreme weather event is occurring).

In another example, the system may be incorporated into an energy management system. The energy management system may be configured to obtain context weather data characterizing the weather in a real-world location of a renewable energy generation facility such as a wind power or solar energy generation facility at one or more preceding time points. The context weather data may be processed as described above, and the renewable energy generation facility, e.g., the wind power or solar energy generation facility, may be controlled in response to the predicted weather data characterizing the predicted weather in the real-world location of the renewable energy generation facility at the corresponding future time point(s). For example, in a solar energy farm solar panels may be tilted or covered to protect the panels from predicted weather hydrometeors of greater than a threshold severity; or in a wind farm the energy generation facility may be configured to maximize output based on the predicted weather; or one or more other power generation sources on the same electrical grid as the renewable energy generation facility may be controlled to increase or decrease power from the other power generation sources for grid balancing in response to a predicted power output from the renewable energy generation facility based on the predicted weather. In a related energy management system instead of controlling the renewal energy generation facility the predicted weather data characterizing the predicted weather in the real-world location of the renewable energy generation facility may be used to send a signal to a consumer of power on the electrical grid to which the renewable energy generation facility is connected, for controlling one or more power-consuming devices of the consumer for load balancing, e.g., in a smart grid, in response to a predicted power output from the renewable energy generation facility based on the predicted weather.

In another example application the system may be incorporated into a flood early-warning system. The flood early-warning system may be configured to obtain context weather data characterizing the weather in a real-world location of an at-risk area at one or more preceding time points. The context weather data may be processed as described above; and the flood early-warning system may output a warning, in response to the predicted weather data characterizing the predicted weather in the real-world location of the at-risk area at the corresponding future time point. For example the warning may be provided in response to the predicted weather forecasting greater than a threshold level of precipitation. A similar system may be used to warn of potential landslides. The warning may be issued via one or more channels, e.g., television, radio, internet, mobile phones, public transport, or public alarms. In some implementations the warning is a public warning such as an audible and/or visual alarm in the real-world location of the at-risk area that can warn of local danger to life or property.

In another example application the system may be incorporated into an air or marine traffic control system. The air or marine traffic control system may be configured to obtain context weather data characterizing the weather in a real-world location of one or more air or marine craft at preceding time points. The context weather data may be processed as described above; and the air or marine traffic control system may output a signal for controlling the flight patterns or marine craft routes of the one or more aircraft or marine craft in the real-world location in response to the predicted temporal sequence characterizing the predicted weather in the real-world location at the corresponding future time point. The signal may be a warning signal or a routing signal; in some implementations it may be automatically provided to the air or marine craft, e.g., for the purpose of enabling the air or marine craft to take evasive action. In some implementations system is an air traffic control system and the real-world location may then be the location of an airport. The signal may be output in response to the predicted weather having greater than a threshold level of severity, e.g., greater than a threshold level of precipitation or hydrometeors, or greater than a threshold level of wind (speed), or greater than a threshold level of a particular wind behavior (e.g., characterized by wind speed and/or direction).

In another example application the system may be incorporated into an energy management system configured to obtain context weather data characterizing the weather in a real-world location of a building or industrial facility at preceding time points. The context weather data may be processed as described above; and control shutters, or a ventilation system, or a temperature control system, of the building or industrial facility in response to the predicted weather data characterizing the predicted weather in the real-world location of the building or industrial facility at the corresponding future time point. Such a system may be used to control a temperature or humidity of the building or industrial facility, or to keep it dry, or to protect the building or industrial facility.

Prior to using the graph neural network 110 to predict weather, the system 100 or another training system trains the graph neural network 110 on training data.

For example, the training data can include multiple sequences of target weather data, i.e., multiple sequences that each include target weather data that has been observed or measured at respective time points. Such training data can be obtained from any of a variety of data sources that compile weather that has been historically observed or measured at different points around the surface (for example, the ERA5 archive of the European Centre for Medium-Range Weather Forecasts, ECMWF).

The graph neural network 110 can be trained using any of a variety of objectives that measure how accurately the graph neural network 110 can predict weather properties.

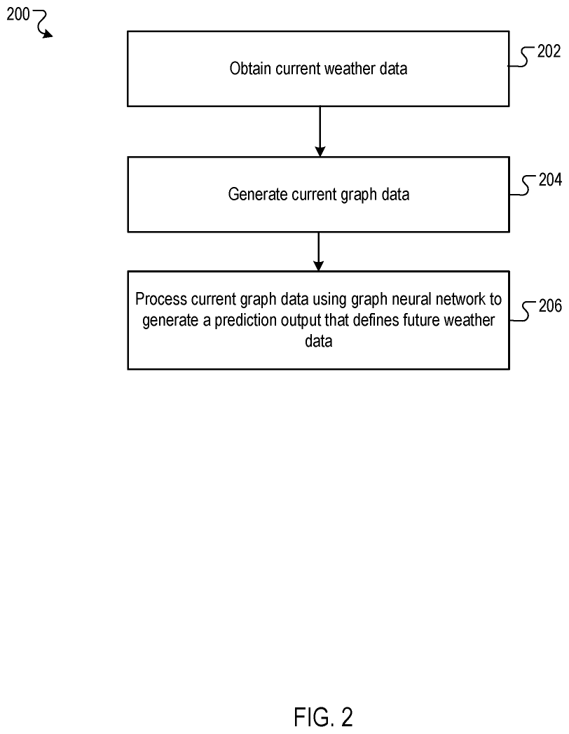

As one example, the training system can train the graph neural network 110 to minimize an objective that measures, for each time step in each sequence of target weather data, either (i) errors between target weather data for the time step and corresponding future weather data generated using the graph neural network 110 for the time step or (ii) errors between a normalization of the target weather data for the time step and a normalization of the corresponding future weather data generated using the graph neural network 110 for the time step. That is, as will be described in more detail below with reference to FIG. 2, in some implementation the output of the graph neural network 110 is in a normalized space. Thus, in these implementations, the system uses errors computed in the normalized space to train the neural network. For example, in the normalized space, each output value can be normalized to have zero mean and unit variance. For example, a respective mean and variance of each output value can be estimated from the corresponding output values at the points on the latitude-longitude grid. The estimated mean may then be subtracted from each of the corresponding output values at the points on the latitude-longitude grid, and the corresponding output values scaled using the estimated variance (e.g. dividing by the corresponding standard deviation). Computing the loss in a normalized space may improve stability during training. The errors may be squared errors, such that the objective minimized by the training is a mean squared error, for example. In some examples, the objective may be a (single) scalar loss obtained by averaging across latitude-longitude, pressure levels, and weather properties. In some examples, the average may be a weighted average, with different latitude-longitude, pressure levels, and/or weather properties being assigned different weights in the objective.

In some cases, the objective can be an auto-regressive training objective. More specifically, in the auto-regressive training objective, for each of one or more time steps in the sequence of target weather data, the corresponding future weather data for the time step is generated by providing, as input to the graph neural network, graph data that is generated using future weather data generated using the graph neural network at one or more preceding time steps.

That is, in these cases, during training, the graph neural network 110 is used to auto-regressively generate respective future weather data at each of multiple time steps starting from each of at least a subset of time steps in each training sequence. That is, although the actual weather is known at training time, the system can still perform auto-regressive prediction. This can improve the model's ability to make accurate forecasts over more than one step at inference time.

In some implementations, the number of auto-regressive steps that are employed before the loss is computed is held fixed throughout training. In some other implementations, the number of auto-regressive steps that are performed is varied as training progresses using a curriculum training schedule (i.e. a schedule in which one or more parameters used during the training is varied during different phases of the training). For example, the curriculum can indicate that for an initial phase of training, only a single auto-regressive step is performed, while for a later phase of training, more than one auto-regressive step is performed. For example, in the later phase of the training the number of auto-regressive steps can be linearly increased as the phase progresses until a maximum number of steps is reached.

In some implementations, the system trains the graph neural network 110 using lower-resolution training data. In other words, in these implementations the target weather data is defined on a grid that has a lower resolution than the grid on which the current weather data is defined after training. Training on lower resolution data can improve the computational efficiency of the training process without significantly harming inference-time performance.

FIG. 2 is a flow diagram of an example process 200 for generating predicted weather data. For convenience, the process 200 will be described as being performed by a system of one or more computers located in one or more locations. For example, a forecasting system, e.g., the forecasting system 100 of FIG. 1, appropriately programmed, can perform the process 200.

The system obtains current weather data for a current time step (step 202). As described above, the current weather data is defined on a latitude-longitude grid over a surface of a body and includes, for each of a plurality of points on the latitude-longitude grid, current weather properties at the point as of the current time step.

The system generates, using the current weather data, current graph data representing a current state of a graph of the surface (step 204).

As described above, the graph is a “multi-mesh” graph of the surface and the current graph data representing the current state of the graph includes a respective embedding for each node in the graph and each edge in the graph.

To generate the embeddings, the system can generate, using at least the current weather data, respective features for each of the nodes and edges in the graph. The system can then process the respective features of each of the nodes and edges in the graph using a corresponding encoder neural network to generate the respective embeddings of each of the nodes and edges. For example, each type of node and edge can have a different corresponding encoder neural network and the encoder neural networks can have been trained jointly with the graph neural network. As discussed, the types of node may comprise mesh nodes and grid nodes, and the types of edge may comprise mesh edges and optionally, grid-to-mesh edges and/or mesh-to-grid edges. For example, the mesh nodes and grid nodes may have different corresponding encoder neural networks, and the mesh edges, grid-to-mesh edges and mesh-to-grid edges may have different corresponding encoder neural networks. The encoder neural network(s) can generally have any appropriate neural network architecture. For example, the neural network(s) can be respective multi-layer perceptrons (MLPs).

For example, the system can generate the respective features for each of the grid nodes at least in part from the current weather properties at the point corresponding to the grid node and generate the respective features for each of the mesh nodes based at least in part on the longitude and latitude of the mesh node. In addition to the current weather properties at the point, the features for a given grid node can optionally include analytically computed features at the point and static features at the point.

As a particular example, the respective features for each of the grid nodes can include respective normalized values for each of one or more of the current weather properties at the point. For example, the values of the grid nodes (i.e., the distribution of values over the grid nodes) can be normalized to have zero mean and unit variance. For example, for each physical variable, the system can compute the per-pressure level mean and standard deviation over a historical period, e.g., the period covered by the training data for the neural network or a different historical period, and use the per-pressure level means and standard deviations to normalize the corresponding values to zero mean and unit variance.

As another example, the respective features for each of the edges can be based on respective positions of each of the two nodes (e.g., locations on the surface of the body) connected by the edge. For example, for mesh edges, mesh-to-grid edges, and grid-to-mesh edges the features can include the length of the edge and the vector difference between the 3d positions of a sender node for the edge and a receiver node for the edge computed in a local coordinate system of the receiver. In some cases, the system can normalize the edge lengths, e.g., based on the length of the longest edge in graph.

The system processes the current graph data using a graph neural network to generate a first prediction output that defines first future weather data that includes, for each of the points on the latitude-longitude grid, predicted weather properties at the point as of a first future time step that is after the current time step (step 206).

For example, the system can process the graph data through a set of graph neural network layers to generate updated embeddings for each of the grid nodes and then process the updated embeddings of the grid nodes using a decoder neural network to generate the first predicted output. For example, the decoder neural network can be an MLP.

The system can process the graph data using graph neural network layers in any of a variety of ways and the graph neural network layers can have any appropriate graph neural network layer architecture. For example, the layer can include any of message passing neural network (MPNN) layer, graph convolutional neural network (GCNN) layers, or graph simulator network (GSN) layers.

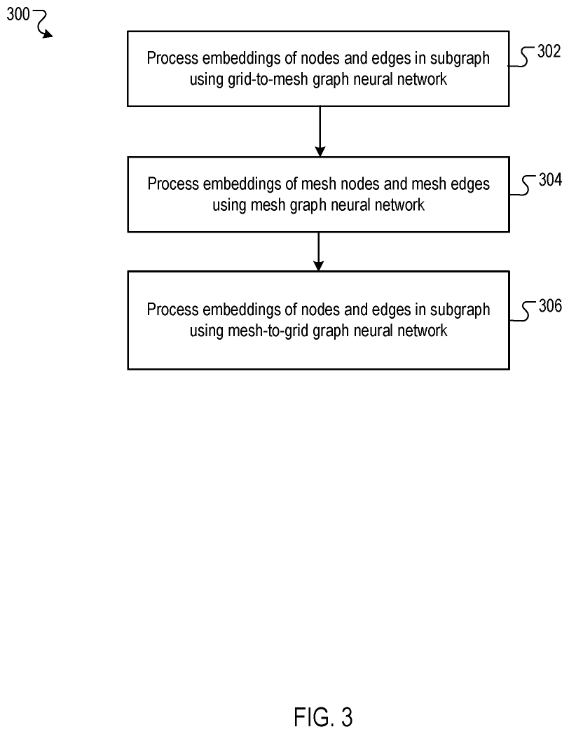

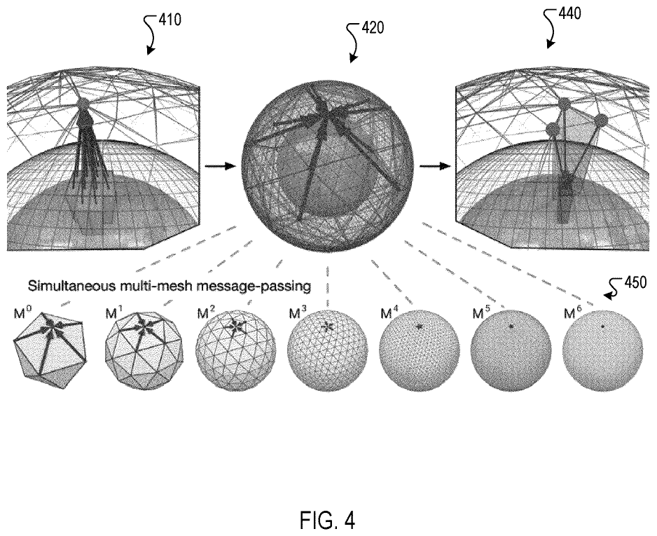

In some implementations, the system processes the graph data using the graph neural network layers in an encode-process-decode configuration. An example technique for generating the updated embeddings of the grid nodes an encode-process-decode configuration is described in more detail below with reference to FIGS. 3 and 4.

Generally, the first prediction output specifies a respective predicted value for each of the weather-dependent properties that are included in the current weather data.

Thus, the weather properties that are specified in the first prediction output can include properties of the surface at the point, properties of the atmosphere above the surface at the point, or both.

For example, surface properties can include any of temperature, wind speed, wind direction, air pressure, precipitation levels, and so on.

Atmospheric properties can include, for each of multiple vertical levels, where each level is a different pressure level above the point, any one of humidity, temperature wind speed, wind direction, geopotential, vertical wind velocity, and so on.

For example, the system can predict the 5 surface properties shown in Table 1 and can predict, for each of the atmospheric property shown in Table 1, a respective value of the property for each of the 37 pressure levels shown in Table 1.

In some implementations, the first prediction output directly specifies the values of the predicted weather properties for each of the points on the grid.

In some other implementations, the first prediction output includes a predicted delta of the weather property between the current time point and the first future time point. Thus, for a given property for a given grid node, the system can generate the predicted property at the first future time point from the property at the current time point and the predicted delta.

As a particular example, the predicted delta of the weather property can be a predicted delta (i.e., difference) between (i) a normalized value of the property at the current time point and (ii) a normalized value of the property at the first future time point.

In this example, to generate the first future weather data from the current weather data and the first prediction output, the system can, for each point and for each of the one or more weather properties, un-normalize the predicted delta and apply the un-normalized predicted delta (difference) to the value of the property at the current time point, e.g., add the un-normalized predicted delta to or subtract the un-normalized predicted delta from the value of the property at the current time point. For example, the predicted delta may be un-normalized using the variance and mean that were used to normalize the corresponding output values by scaling the using the variance (e.g., multiplying by the corresponding standard deviation) and then adding the mean.

FIG. 3 is a flow diagram of an example process 300 for processing the graph data using the graph neural network. For convenience, the process 300 will be described as being performed by a system of one or more computers located in one or more locations. For example, a forecasting system, e.g., the forecasting system 100 of FIG. 1, appropriately programmed, can perform the process 300.

In the example of FIG. 3, the system performs the processing of the graph neural network using an encode-process-decode configuration.

The system processes the respective embeddings of each of the nodes and edges in a bipartite subgraph of the graph that includes the grid nodes, the mesh nodes, and the grid-to-mesh edges using a grid-to-mesh graph neural network to update the respective embeddings of at least the mesh nodes (step 302). A bipartite subgraph comprises nodes that can be divided into two disjoint (non-overlapping) sets, in this case the grid nodes and the mesh nodes, with every edge (in this case, grid-to-mesh edge) connecting respective nodes that belong to different ones of the disjoint sets. Generally, the grid-to-mesh graph neural network includes multiple graph neural network layers, e.g., having any appropriate architecture as described above. In some cases, the graph neural network layers are configured to update only the embeddings of the mesh nodes while, in other cases, the graph neural network layers also update the embeddings of one or more of the grid nodes, the grid-to-mesh edges, or both.

Thus, the grid-to-mesh graph neural network serves as an “encoder” that encodes information from the grid nodes onto the mesh nodes in the multi-mesh representation.

After updating the respective embeddings of at least the mesh nodes and the grid-to-mesh edges, the system processes the respective embeddings of each of the nodes and edges in the graph to update the embeddings of the grid nodes.

For example, the system can process the respective embeddings of each of the mesh nodes and mesh edges using a mesh graph neural network to update the respective embeddings of at least each of the mesh nodes (step 304). Generally, the mesh graph neural network includes multiple graph neural network layers, e.g., having any appropriate architecture as described above. In some cases, the graph neural network layers are configured to update only the embeddings of the mesh nodes while, in other cases, the graph neural network layers also update the embeddings of the mesh edges.

Thus, the system uses the mesh graph neural network to propagate information across the multiple scales of the mesh. In particular, the system can use the coarser mesh edges to propagate long distance dependencies and the finer mesh edges to represent local interactions. In other words, the mesh graph neural network serves as a processor that communicates information across the multi-mesh.

After updating the embedding of the mesh nodes, the system processes the respective embeddings of each of the nodes and edges in a bipartite subgraph of the graph that includes the grid nodes, the mesh nodes, and the mesh-to-grid edges using a mesh-to-grid graph neural network to update the respective embeddings of each of the grid nodes (step 306). Generally, the mesh-to-grid graph neural network includes multiple graph neural network layers, e.g., having any appropriate architecture as described above. In some cases, the graph neural network layers are configured to update only the embeddings of the grid nodes while, in other cases, the graph neural network layers also update the embeddings of one or more of the mesh nodes, the mesh-to-grid edges, or both.

Thus, the mesh-to-grid graph neural network serves as a “decoder” that decodes information from the mesh nodes to the grid nodes.

FIG. 4 shows an example of the encode-process-decode configuration.

As shown in FIG. 4, the system 100 uses the grid-to-mesh neural network to encode 410 information from the grid nodes onto the mesh nodes by way of the grid-to-mesh edges. For example, FIG. 4 shows information from a set of grid nodes that are connected to a particular mesh node by respective grid-to-mesh edges being propagated into the particular mesh node by way of message passing across the respective grid-to-mesh edges.

The system 100 then uses the mesh graph neural network to process 420 the information that has been encoded in the mesh nodes by performing multi-mesh message passing 450.

In particular, in the example of FIG. 4, the hierarchy of meshes includes seven levels M0 through M6, with M0 being the coarsest level and M6 being the finest level. As shown in FIG. 6, by performing the multi-mesh message passing, the system can simultaneously pass information across long distances through the coarsest levels and locally across the finest levels. Thus, the edges between mesh nodes at the coarsest levels reflect long-range dependencies and edges between mesh nodes at the finest levels represent local interactions. The hierarchy of meshes can be constructed by, for example, dividing a regular icosahedron (12 nodes and 20 faces) iteratively 6 times to obtain a hierarchy of icosahedral meshes with a total of 40,962 nodes and 81,920 faces at the finest level.

The system 100 then uses the mesh-to-grid neural network to decode 430 the processed information from the mesh nodes into the grid nodes by way of the mesh-to-grid edges. For example, FIG. 4 shows information from a set of mesh nodes that are connected to a particular grid node by respective mesh-to-grid edges being propagated into the particular grid node by way of message passing across the respective mesh-to-grid edges.

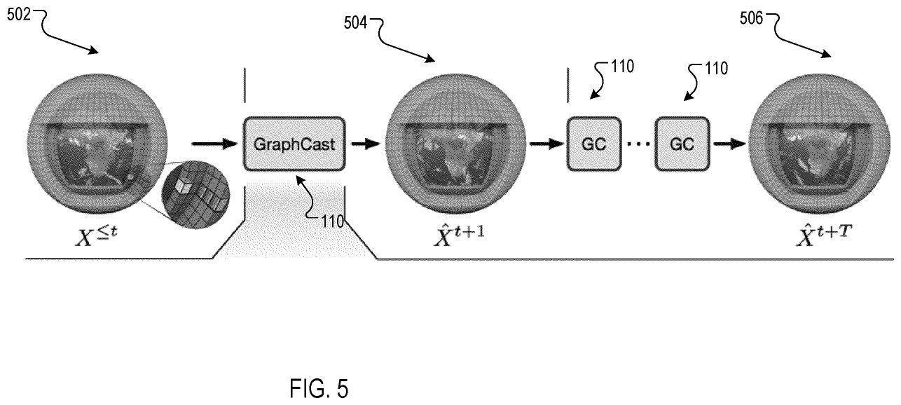

FIG. 5 shows an example of auto-regressively rolling out a weather forecast.

In particular, as shown in FIG. 5, the system 100 receives actual weather data 502 at time point t (and optionally one or more time points that are earlier than t). The system uses the graph neural network (“graphcast”) 110 to generate predicted weather data 504 at time point t+1. The system then uses the predicted weather 504 (and optionally the actual weather data 502 at time point t) as input to the graph neural network 110 to generate predicted weather data 504 at time point t+2. The system can continue auto-regressively feeding predictions from the graph neural network 110 as input to the graph neural network 110 across multiple different time points until generating predicted weather data 506 at time point t+T (where T is the number of autoregressive iterations).

Graph neural networks are described in Battaglia et al. arXiv: 1806.01261, for example.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining current weather data for a current time step, wherein the current weather data is defined on a latitude-longitude grid over a surface of a body and comprises, for each of a plurality of points on the latitude-longitude grid, current weather properties at the point as of the current time step;
generating, using the current weather data, current graph data representing a current state of a graph of the surface, the graph comprising:
a plurality of nodes, the plurality of nodes comprising a plurality of grid nodes that each correspond to one of the points on the latitude-longitude grid and a plurality of mesh nodes that each correspond to a node in a first mesh that is placed around the surface at a first scale; and
a plurality of edges, the plurality of edges comprising a plurality of mesh edges that include (i) a respective first scale mesh edge connecting each pair of mesh nodes that are connected in the first mesh that is placed around the surface at the first scale and (ii) for each of one or more second scales that are coarser than the first scale, a respective second scale mesh edge connecting each pair of mesh nodes that would be connected in a corresponding second mesh that is placed around the surface at the second scale, and
the current graph data comprising respective embeddings for each of the nodes and edges in the graph; and
processing the current graph data using a graph neural network to generate a first prediction output that defines first future weather data that includes, for each of the plurality of points on the latitude-longitude grid, predicted weather properties at the point as of a first future time step that is after the current time step.

2. The method of claim 1, wherein the current weather data comprises, for each of the plurality of points on the latitude-longitude grid, weather properties at the point as of one or more preceding time steps that are each earlier than the current time step.

3. The method of claim 1, further comprising:
generating, from at least the first future weather data, first future graph data that represents a first future state of the graph of the surface; and
processing the first future graph data using the graph neural network to generate a second prediction output that defines second future weather data that includes, for each of the plurality of points on the latitude-longitude grid, predicted weather properties at the point as of a second future time step that is after the first future time step.

4. The method of claim 3, wherein the first future weather data includes, for each of the plurality of points on the latitude-longitude grid, (i) the current weather properties at the point as of the current time step and (ii) the predicted weather properties at the point as of the first future time step.

5. The method of claim 1, wherein the first prediction output includes, for each point and for each of one or more of the weather properties, a predicted delta of the weather property between the current time point and the first future time point.

6. The method of claim 1, wherein the plurality of edges include a plurality of grid-to-mesh edges, wherein each of the plurality of grid-to-mesh edges is a unidirectional edge from a respective grid node to a respective mesh node, and wherein a given grid node is connected to a given mesh node by a grid-to-mesh edge only if a distance between the given mesh node and the given grid node is less than a threshold distance.

7. The method of claim 6, wherein the threshold distance is based on lengths of the edges in the first mesh at the first scale.

8. The method of claim 1, wherein the plurality of edges include a plurality of mesh-to-grid edges, wherein each of the plurality of mesh-to-grid edges is a unidirectional edge from a respective mesh node to a respective grid node, and wherein a given mesh node is connected to a given grid node by a mesh-to-grid edge only if the given mesh node is adjacent to a face of the first mesh at the first scale that contains the given grid node.

9. The method of claim 1, wherein generating the current graph data comprises:
generating, using at least the current weather data, respective features for each of the nodes and edges in the graph; and
processing the respective features of each of the nodes and edges in the graph using a corresponding encoder neural network to generate the respective embeddings of each of the nodes and edges.

10. The method of claim 9, wherein each type of node and edge has a different corresponding encoder neural network.

11. The method of claim 9, wherein the respective features for each of the grid nodes are generated at least in part from the current weather properties at the point and wherein the respective features for each of the mesh nodes are generated based at least in part on a longitude and latitude of the mesh node.

12. The method of claim 11, wherein the respective features for each of the grid nodes include respective normalized values for each of one or more of the current weather properties at the point.

13. The method of claim 9, wherein the respective features for each of the edges are based on respective positions of each of the two nodes connected by the edge.

14. The method of claim 6, wherein processing the current graph data using a graph neural network to generate a first prediction output that defines first future weather data comprises:
processing the respective embeddings of each of the nodes and edges in a bipartite subgraph of the graph that includes the grid nodes, the mesh nodes, and the grid-to-mesh edges using a grid-to-mesh graph neural network to update the respective embeddings of at least the mesh nodes;
after updating the respective embeddings of at least the mesh nodes and the grid-to-mesh edges, processing the respective embeddings of each of the nodes and edges in the graph to update the embeddings of the grid nodes; and
generating the first prediction output from the updated embeddings of the grid nodes.

15. The method of claim 14, wherein processing the respective embeddings of each of the nodes and edges in the graph to update the embeddings of the grid nodes comprises:
processing the respective embeddings of each of the mesh nodes and mesh edges using a mesh graph neural network to update the respective embeddings of at least each of the mesh nodes.

16. The method of claim 14, wherein the plurality of edges include a plurality of mesh-to-grid edges, wherein each of the plurality of mesh-to-grid edges is a unidirectional edge from a respective mesh node to a respective grid node, and wherein a given mesh node is connected to a given grid node by a mesh-to-grid edge only if the given mesh node is adjacent to a face of the first mesh at the first scale that contains the given grid node, and wherein processing the respective embeddings of each of the nodes and edges in the graph to update the embeddings of the grid nodes comprises:
processing the respective embeddings of each of the nodes and edges in a bipartite subgraph of the graph that includes the grid nodes, the mesh nodes, and the mesh-to-grid edges using a mesh-to-grid graph neural network to update the respective embeddings of each of the grid nodes.

17. The method of claim 14, wherein generating the first predicted output comprises:
processing the updated embeddings of the grid nodes using a decoder neural network to generate the first predicted output.

18. The method of claim 1, wherein the mesh at the first scale is an icosahedral mesh over the surface.

19. The method of claim 5, wherein the predicted delta of the weather property is a predicted delta between a normalized value of the property at the current time point and a normalized value of the property at the first future time point, and wherein the method further comprises generating the first future weather data from the current weather data and the first prediction output, comprising:
for each point and for each of the one or more weather properties, un-normalizing the predicted delta and applying the un-normalized predicted delta to the value of the property at the current time point.

20. The method of claim 1, wherein the first mesh and the one or more second meshes define a mesh hierarchy of meshes at different scales, and wherein, for each second mesh, a respective different subset of the mesh nodes correspond to nodes from the second mesh.

21. The method of claim 20, wherein edges between mesh nodes that correspond to nodes from the one or more second meshes represent long distance dependencies and edges between mesh nodes that correspond to nodes from the first mesh represent local interactions.

22. The method of claim 1, wherein a time interval between each time step is between three hours and twelve hours.

23. The method of claim 22, wherein the time interval is six hours.

24. The method of claim 1, wherein the graph neural network has been trained on training data, wherein the training data comprises a plurality of sequences of target weather data to minimize an objective that measures, for each time step in each sequence of target weather data, either (i) errors between target weather data for the time step and corresponding future weather data generated using the graph neural network for the time step or (ii) errors between a normalization of the target weather data for the time step and a normalization of the corresponding future weather data generated using the graph neural network for the time step.

25. The method of claim 24, wherein the objective is an auto-regressive training objective in which, for each of one or more time steps in the sequence of target weather data, the corresponding future weather data for the time step is generated by providing, as input to the graph neural network, graph data that is generated using future weather data generated using the graph neural network at one or more preceding time steps.

26. The method of claim 25, wherein, during training, the graph neural network is used to auto-regressively generate respective future weather data at each of multiple time steps starting from each of at least a subset of time steps in each training sequence.

27. The method of claim 24, wherein the target weather data is defined on a grid that has a lower resolution than the grid on which the current weather data is defined.

28. The method of claim 24, wherein the neural network has been trained using a curriculum training schedule that varies a number of auto-regressive steps that are performed.

29. The method of claim 1, further comprising generating an alert whenever a given predicted weather property satisfies a specified threshold.

30. The method of claim 1, wherein the predicted weather output characterizes the predicted weather at a real-world location of a renewable energy generation facility, the method further comprising:
(i) controlling the renewable energy generation facility in response to the predicted weather at the real-world location; or
(ii) sending, to a consumer of power on an electrical grid to which the renewable energy generation facility is connected, a signal in response to a predicted power output from the renewable energy generation facility based on the predicted weather at the real-world location.

31. The method of claim 1, wherein the predicted weather output characterizes the predicted weather at a real-world location, the method further comprising outputting a signal for controlling the flight patterns or marine craft routes of one or more aircraft or marine craft in response to the predicted weather at the real-world location.

32. The method of claim 1, wherein the predicted weather output characterizes the predicted weather at a real-world location of a building or industrial facility, the method further comprising controlling shutters, or a ventilation system, or a temperature control system, of the building or industrial facility in response to the predicted weather at the real-world location.

33. A system comprising:
one or more computers; and
one or more storage devices communicatively coupled to the one or more computers, wherein the one or more storage devices store instructions that, when executed by the one or more computers, cause the one or more computers to perform operations comprising:
obtaining current weather data for a current time step, wherein the current weather data is defined on a latitude-longitude grid over a surface of a body and comprises, for each of a plurality of points on the latitude-longitude grid, current weather properties at the point as of the current time step;
generating, using the current weather data, current graph data representing a current state of a graph of the surface, the graph comprising:
a plurality of nodes, the plurality of nodes comprising a plurality of grid nodes that each correspond to one of the points on the latitude-longitude grid and a plurality of mesh nodes that each correspond to a node in a first mesh that is placed around the surface at a first scale; and
a plurality of edges, the plurality of edges comprising a plurality of mesh edges that include (i) a respective first scale mesh edge connecting each pair of mesh nodes that are connected in the first mesh that is placed around the surface at the first scale and (ii) for each of one or more second scales that are coarser than the first scale, a respective second scale mesh edge connecting each pair of mesh nodes that would be connected in a corresponding second mesh that is placed around the surface at the second scale, and
the current graph data comprising respective embeddings for each of the nodes and edges in the graph; and
processing the current graph data using a graph neural network to generate a first prediction output that defines first future weather data that includes, for each of the plurality of points on the latitude-longitude grid, predicted weather properties at the point as of a first future time step that is after the current time step

34. One or more non-transitory computer storage media storing instructions that when executed by one or more computers cause the one or more computers to perform operations comprising:
obtaining current weather data for a current time step, wherein the current weather data is defined on a latitude-longitude grid over a surface of a body and comprises, for each of a plurality of points on the latitude-longitude grid, current weather properties at the point as of the current time step;
generating, using the current weather data, current graph data representing a current state of a graph of the surface, the graph comprising:
a plurality of nodes, the plurality of nodes comprising a plurality of grid nodes that each correspond to one of the points on the latitude-longitude grid and a plurality of mesh nodes that each correspond to a node in a first mesh that is placed around the surface at a first scale; and
a plurality of edges, the plurality of edges comprising a plurality of mesh edges that include (i) a respective first scale mesh edge connecting each pair of mesh nodes that are connected in the first mesh that is placed around the surface at the first scale and (ii) for each of one or more second scales that are coarser than the first scale, a respective second scale mesh edge connecting each pair of mesh nodes that would be connected in a corresponding second mesh that is placed around the surface at the second scale, and
the current graph data comprising respective embeddings for each of the nodes and edges in the graph; and
processing the current graph data using a graph neural network to generate a first prediction output that defines first future weather data that includes, for each of the plurality of points on the latitude-longitude grid, predicted weather properties at the point as of a first future time step that is after the current time step
